(19) United States
(12) Patent Application Publication
(10) Pub. No.: US 2024/0113468 A1
(43) Pub. Date: Apr. 4, 2024

(54) Pivoting Electrical Receptacle

(71) Applicant: Scott Pregeant, Houma, LA (US)

(72) Inventor: Scott Pregeant, Houma, LA (US)

(21) Appl. No.: 17/937,613

(22) Filed: Oct. 3, 2022

(51) Int. Cl. H01R 13/518; H01R 25/00

(52) U.S. Cl. CPC H01R 13/518; H01R 25/006

(57) ABSTRACT

A pivoting electrical receptacle assembly is provided, comprising an enclosure having at least one mounting bracket extending outside the enclosure, wherein the enclosure includes a plurality of internal wire terminals and a plurality of external wire terminals. The enclosure includes an electrical receptacle having at least one socket and a plurality of receptacle wire terminals, wherein the receptacle is pivotably positioned within the enclosure. A plurality of jumper wires are electrically connected between the receptacle wire terminals and the internal wire terminals such that an electrical current connected to the external wire terminals energizes the socket through any pivoting position of the receptacle within the enclosure. Optional springs are positioned on the pivots to enable return of the receptacle to a neutral or central position within the enclosure.

### CROSS-REFERENCE TO RELATED APPLICATIONS

Not applicable.

### BACKGROUND OF THE INVENTION

### 1. Field of the Invention

The present invention relates to electrical receptacles, and more particularly to receptacles which pivot from a neutral position.

### 2. Prior Art

Conventional electrical receptacles often comprise a preassembled double-receptacle configuration which is mounted flush with a wall and connected to the residential or commercial electrical power source. Modern receptacles include a front face having at least two sockets, where each socket includes hot, neutral, and ground slots for engagement with the 2-prong or 3-prong plug of an appliance power cord, and a rear portion that includes common terminals for hot, neutral, and ground wires from the source. The receptacle assembly further includes an integral mounting bracket, sometimes referred to as “ears”, for fastening the receptacle to an electrical box recessed into the wall so that the mounted receptacle is flush with the wall while the electrical connections and wires are within the rear volume of the box enclosure. A decorative or trim cover is typically installed over the receptacle to expose the sockets while hiding the connections within the electrical box.

After plugging an appliance cord into a socket, especially an appliance that is moved during operation, there is often stress placed on the plug and the socket when the maximum length of the power cord is reached. This can result in abrupt removal of the plug from the receptacle, but also damage to the plug, the prongs, or the receptacle itself, sometimes jeopardizing the integrity of the electrical connections within the cord or the receptacle.

In response to this problem, and particularly with respect to receptacles which are installed in a vertical orientation, i.e. having upper and lower sockets, the inventor of the present invention has previously developed a pivoting electrical receptacle as described and claimed in U.S. Pat. No. 9,478,920. The design includes an upper and lower spring-loaded pivot that permits the receptacle to rotate relative to its mounting bracket when the inserted plug is moved, and which returns to a neutral or flush position when the receptacle is not being used. The challenge with such a design, however, is that the receptacle is connected directly to the source power wires in the building, typically 12-gauge or 14-gauge wires, which can be relatively stiff and resistant to movement, particularly given the very limited space for rotation within the electrical box.

Therefore, a further need exists for an electrical receptacle design which enables pivoting of the receptacle, but which allows for easier movement of the receptacle without causing movement of the source power wires. Such a design would include a self-contained assembly that is installed within the electrical box and connected to the source power wires, and which would rely on intermediate or jumper wires within the assembly itself for conducting the necessary current to the receptacle. Also, this new design would enable independent pivoting of each socket in a double-socket configuration to reduce wear and fatigue on its adjacent socket.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows an exploded view of a preferred embodiment of the present invention.

FIG. 2 shows a front view of the invention of FIG. 1 in an installed assembly.

FIG. 3 shows a side sectional view of the invention of FIG. 1.

FIG. 4 shows a front view of the invention of FIG. 1 with the receptacle and cover prior to installation.

FIG. 5 shows a top section view of the invention of FIG. depicting the receptacle in its pivoted and neutral orientations in response to the movement of the plug.

FIG. 6 shows an alternative embodiment of the invention which includes upper and lower springs to return the receptacle to a neutral position.

FIG. 7 shows another alternative embodiment of the invention which enables independent pivoting of each of the first and second sockets of the receptacle.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

This invention builds upon and introduces novel features based upon a related device developed by the present inventor, U.S. Pat. No. 9,478,920. The disclosures of that patent are hereby incorporated by reference into this application.

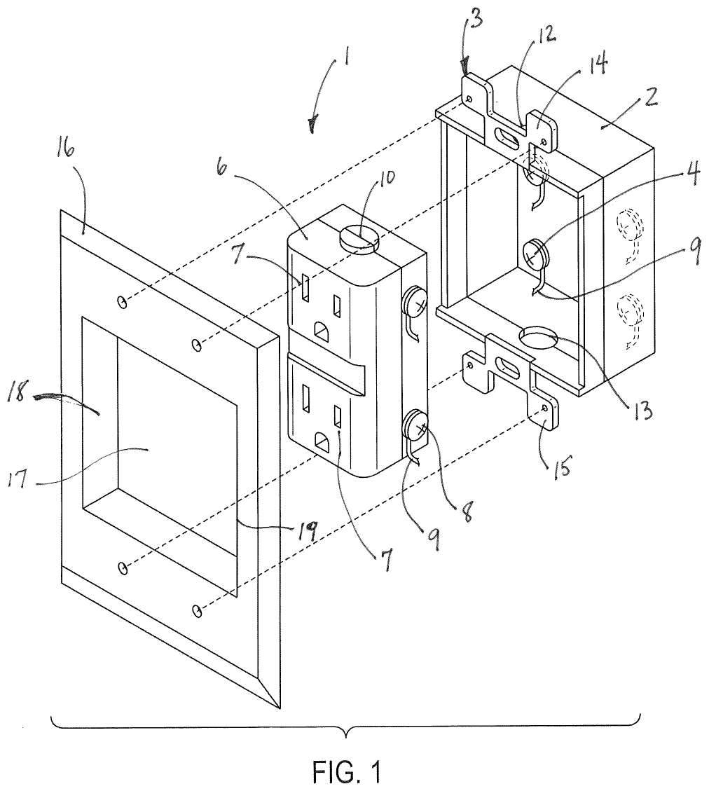

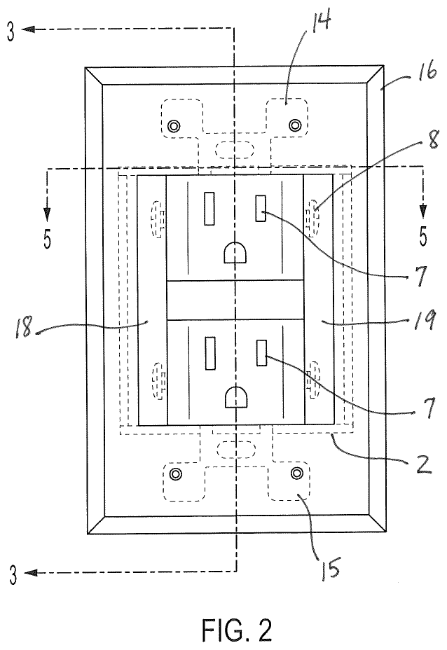

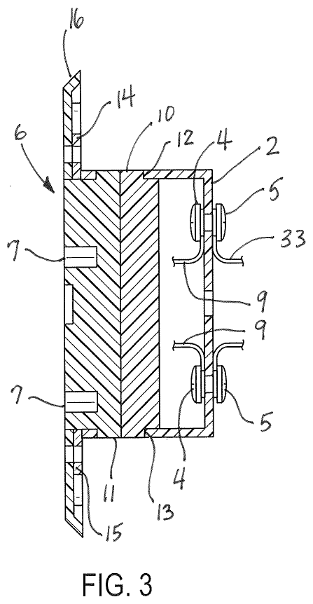

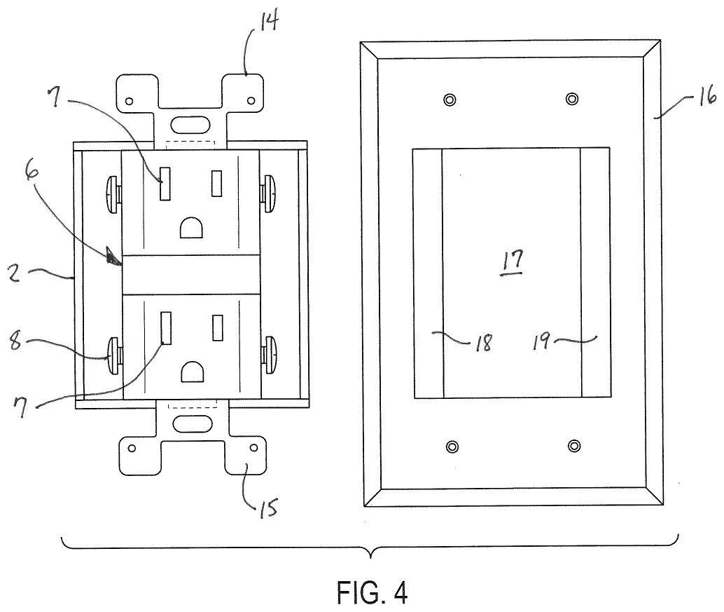

Turning now to the figures, a preferred embodiment of the present invention is shown in FIGS. 1-5 which employs an electrical receptacle which pivots within an intermediate enclosure, and which includes additional features as described below.

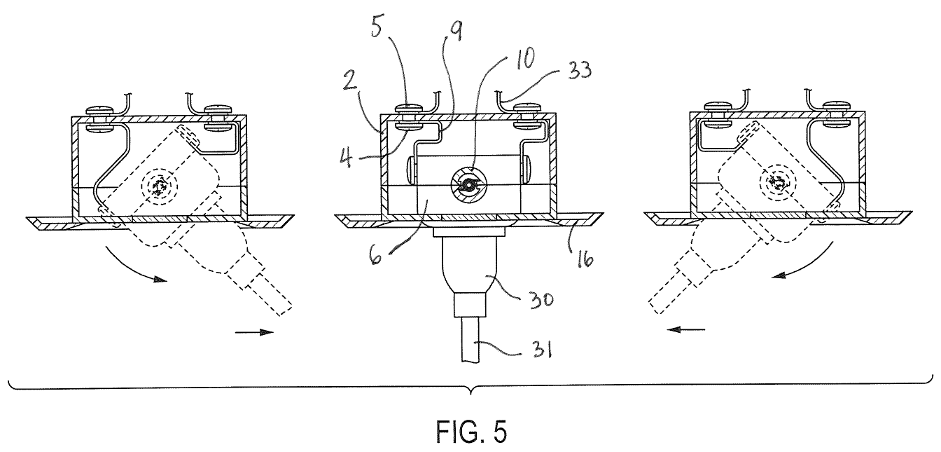

With reference to FIG. 1, a pivoting electrical receptacle assembly 1 is provided, comprising an enclosure 2 having at least one mounting bracket 3 extending outside the enclosure 2. The enclosure 2 includes a plurality of internal wire terminals 4 for connection to corresponding receptacle wire terminals 8 on a receptacle 6 through the use of a plurality of jumper wires 9. The jumper wires 9 are sufficiently flexible to enable pivoting of the receptacle 6 through a predetermined range of motion as shown in FIG. 5. The electrical receptacle 6 has at least one socket 7, but preferably two sockets 7, similar to conventional receptacles.

A plurality of external wire terminals 5 are positioned on a rear surface of the enclosure 2 for connection to source wires 33 carrying electrical current from the building. The receptacle 6 is pivotably positioned within the enclosure 2 as will be further described below. In an installed configuration, when the source wires 33 from the building are connected to the external wire terminals 5, the sockets 7 are energized through any pivoting position of the receptacle 6 within the enclosure 2.

In order to provide the required pivoting movement of the receptacle 6, the receptacle 6 includes opposing pivot posts 10, 11, which matingly engage opposing pivot holes 12, 13, formed into the enclosure 2. Thus, when assembled, the pivot posts 10, 11, of the receptacle 6 are pivotally engaged with the pivot holes 12, 13, and the receptacle is fully recessed into the enclosure 2 such that the front faces of the sockets 7 are substantially aligned with the mounting bracket 3.

The mounting bracket 3 includes opposing bracket members 14, 15, alignable with fastener locations on an electrical receptacle box (not shown), as is commonly employed in conventional receptacles. Once the enclosure 2 and the pivoting receptacle 6 are installed into an electrical box or housing in the wall, a cover 16 is matably engageable with the bracket members 14, 15, as in conventional receptacle installations. Importantly, the cover 16 also includes an opening 17 having opposing beveled edges 18, 19. The beveled edges 18, 19 provide space for movement of the plug 30 on an electrical cord 31 as the receptacle 6 pivots from side to side in response to forces applied to the cord 31 as shown in FIG. 5.

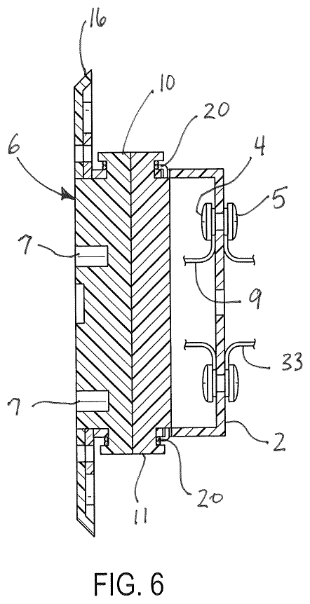

With reference to FIG. 6, an alternative embodiment of the present invention is shown wherein each of the opposing pivot posts 10, 11, includes at least one resilient member 20, such as a coiled spring or similar device, operatively positioned between the receptacle 6 and the enclosure 2. In this embodiment, one end of each of the springs 20 is engaged with a hole in the enclosure 2, establishing a neutral or front-facing position of the receptacle 6. If the receptacle 6 is caused to pivot to either side by an external force, the springs 20 cause the receptacle 6 to return to the neutral position when that external force is removed.

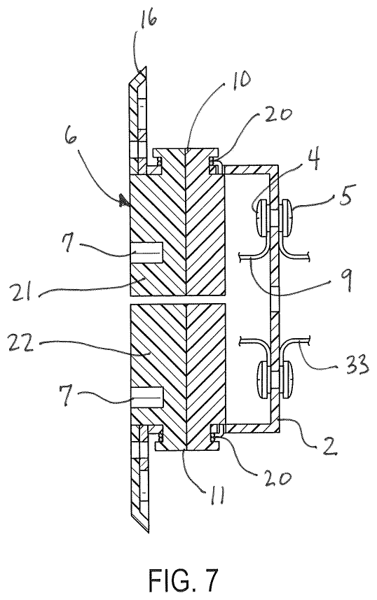

With reference to FIGS. 7, a further alternative embodiment is shown wherein the receptacle 6 includes a first socket 21 and a second socket 22, and wherein the first socket 21 and the second socket 22 are independently pivotable relative to the enclosure 2. Similar to the embodiment of FIG. 6, the pivot post 10 on the first socket 21 and the pivot post 11 on the second socket 22 each includes at least one resilient member 20, such as a coiled spring, operatively positioned between the receptacle 6 and the enclosure 2. In this manner, the springs 20 are adapted to bias the first socket 21 and the second socket 22 to a front-facing position independently of one another.

As can be seen, this new design is a significant advance over the prior art, and in particular over the inventor's prior patent, U.S. Pat. No. 9,478,920, because it does not rely upon any movement of the source wires 33 from the building. Rather, the jumper wires 9 maintain the required electrical connection to the source wires 33, but are flexible enough to withstand fatigue resulting from frequent pivoting of the receptacle 6.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only, and the scope of the present invention is to be limited only by the following claims.

The invention claimed is:

1. A pivoting electrical receptacle assembly, comprising:
an enclosure having at least one mounting bracket extending outside the enclosure, wherein the enclosure includes a plurality of internal wire terminals and a plurality of external wire terminals;
an electrical receptacle having at least one socket and a plurality of receptacle wire terminals, wherein the receptacle is pivotably positioned within the enclosure; and
a plurality of jumper wires electrically connected between the receptacle wire terminals and the internal wire terminals such that an electrical current connected to the external wire terminals energizes the socket through any pivoting position of the receptacle within the enclosure.

2. The assembly of claim 1, wherein the receptacle includes opposing pivot posts, wherein the enclosure includes opposing pivot holes, and wherein the pivot posts of the receptacle are pivotally engaged with the pivot holes.

3. The assembly of claim 1, wherein the mounting bracket includes opposing bracket members alignable with fastener locations on an electrical receptacle box.

4. The assembly of claim 1, wherein the receptacle includes two sockets.

5. The assembly of claim 1, further comprising a cover matably engageable with the bracket members.

6. The assembly of claim 5, wherein the cover includes an opening having opposing beveled edges.

7. The assembly of claim 1, wherein the jumper wires are sufficiently flexible to enable pivoting of the receptacle through a predetermined range of motion.

8. The assembly of claim 1, wherein each of the opposing pivot posts includes at least one resilient member operatively positioned between the receptacle and the enclosure adapted to bias the receptacle to a front-facing position.

9. The assembly of claim 8, wherein the resilient member is a spring.

10. The assembly of claim 1, wherein the receptacle includes a first socket and a second socket, and wherein the first socket and the second socket are independently pivotable relative to the enclosure.

11. The assembly of claim 10, wherein the pivot post on the first socket and the pivot post on the second socket each includes at least one resilient member operatively positioned between the receptacle and the enclosure adapted to bias the first socket and the second socket to a front-facing position.

12. The assembly of claim 11, wherein the resilient member is a spring.
